(19) United States
(12) Patent Application Publication
(10) Pub. No.: US 2015/0066208 A1
(43) Pub. Date: Mar. 5, 2015

(54) ROBOTIC OR MECHANICAL HAND WITH ALARM FUNCTION

(71) Applicant: HON HAI PRECISION INDUSTRY CO., LTD., New Taipei (TW)

(72) Inventor: LI-CHIN LU, New Taipei (TW)

(73) Assignee: HON HAI PRECISION INDUSTRY CO., LTD., New Taipei (TW)

(21) Appl. No.: 14/093,053

(22) Filed: Nov. 29, 2013

(30) Foreign Application Priority Data
Aug. 27, 2013 (CN) 2013103765994

(51) Int. Cl. B25J 9/16

(52) U.S. Cl. CPC B25J 9/1612
USPC 700/259

(57) ABSTRACT

A robotic or mechanical hand includes a number of infrared distance sensors, an alarm unit, a driving unit, and a processing unit. When the presence of a person or object within a certain adjustable proximity is detected, the hand raises an alarm for a preset time period and directs the driving unit to stop the motion of the mechanical hand.

### BACKGROUND

1. Technical Field

The present disclosure relates to mechanical hands, and particularly, a mechanical hand with an alarm function.

2. Description of Related Art

During the rotation of a robot arm or mechanical actuator, people or foreign bodies near to the arm or actuator may be inadvertently injured or damaged, or damage to the arm or actuator may occur.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 shows an embodiment of a mechanical hand.

FIG. 2 is another isometric view of the mechanical hand of FIG. 1, viewed from anther view.

FIG. 3 shows another embodiment of a mechanical hand, showing a different distribution of infrared distance sensors from that's of FIG. 1.

FIG. 4 shows a block diagram of a mechanical hand.

### DETAILED DESCRIPTION

Embodiments of the present disclosure are described, with reference to the accompanying drawings.

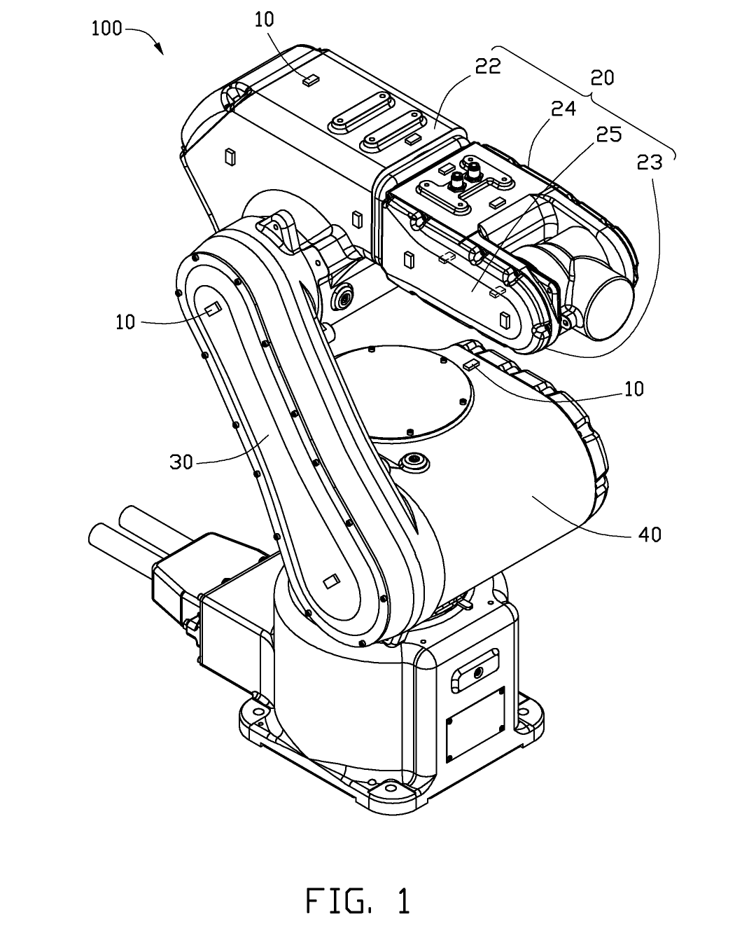

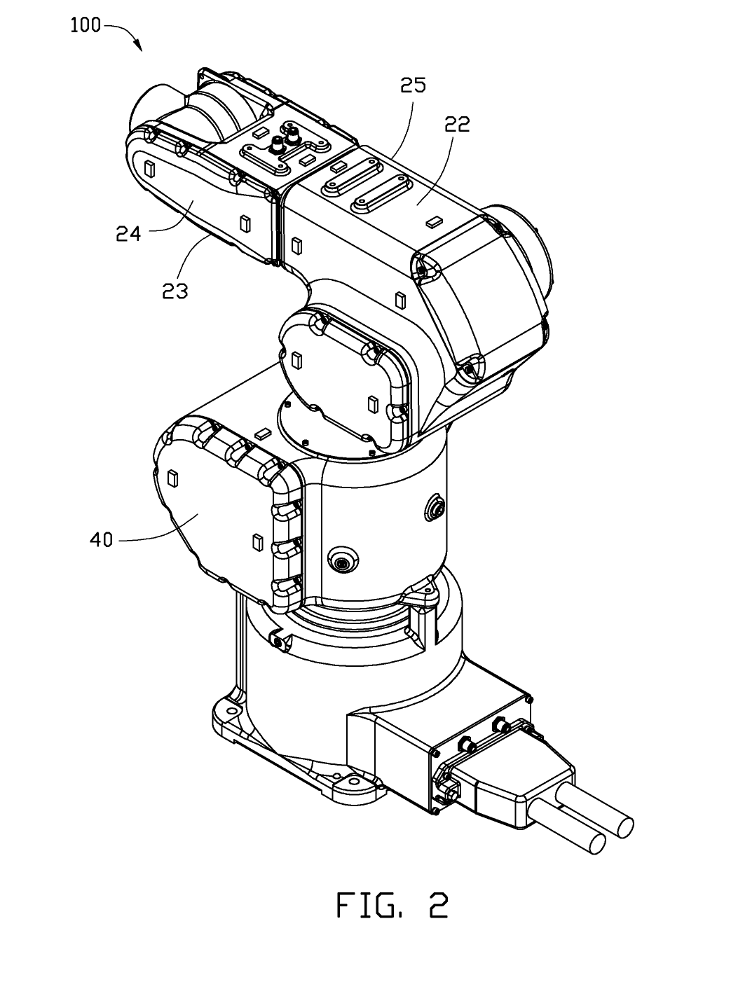

FIGS. 1-2 show an embodiment of a mechanical hand 100. The mechanical hand 100 includes a number of infrared distance sensors 10. The sensors 10 are employed to detect the distance between the mechanical hand 100 and people or foreign bodies. When the distanced sensed by any of the sensors 10 is less than or equal to a preset value, the mechanical hand 100 raises an alarm and stops moving. In this embodiment, the preset value is 50 mm. The preset value can be changed according to need.

In this embodiment, the mechanical hand 100 includes a main body 11. The main body 11 includes a rotary arm 20, a first rotary shaft 30 rotatably connected to the rotary arm 20, and a second rotary shaft 40 rotatably connected to the first rotary shaft 30. The rotary arm 20 includes an upper surface 22, a lower surface 23 opposite to the upper surface 22, a left sidewall 24, and a right sidewall 25 opposite to the left sidewall 24. The distribution of the sensors 10 can be changed according to need. In a first embodiment, the sensors 10 are arranged on the outer surfaces of the rotary arm 20, the first rotary shaft 30, and the second rotary shaft 40, thus the sensors 10 can detect whether or not people or foreign bodies are near to the mechanical hand 100 in any direction.

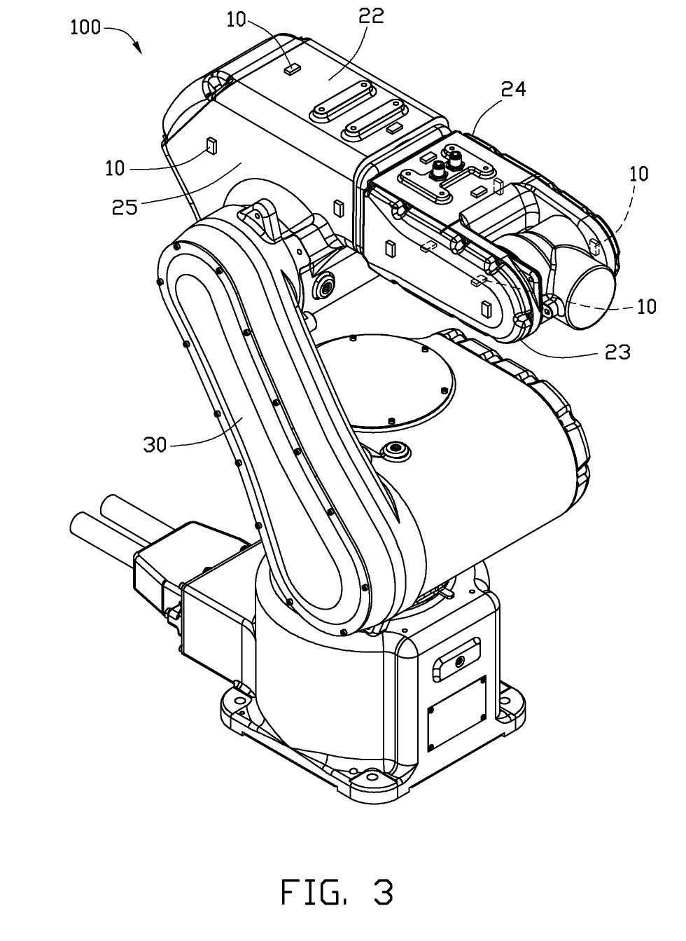

Referring to FIG. 3, in a second embodiment, the sensors 10 includes a first, second, third, and fourth sensor arrays. The first sensor array is arranged on the upper surface 22 of the rotary arm 20, the second sensor array is arranged on the lower surface of the rotary arm 20, the third sensor array is arranged on the left sidewall 24 of the rotary arm 20, and the fourth sensor array is arranged on the right sidewall 25 of the rotary arm 20.

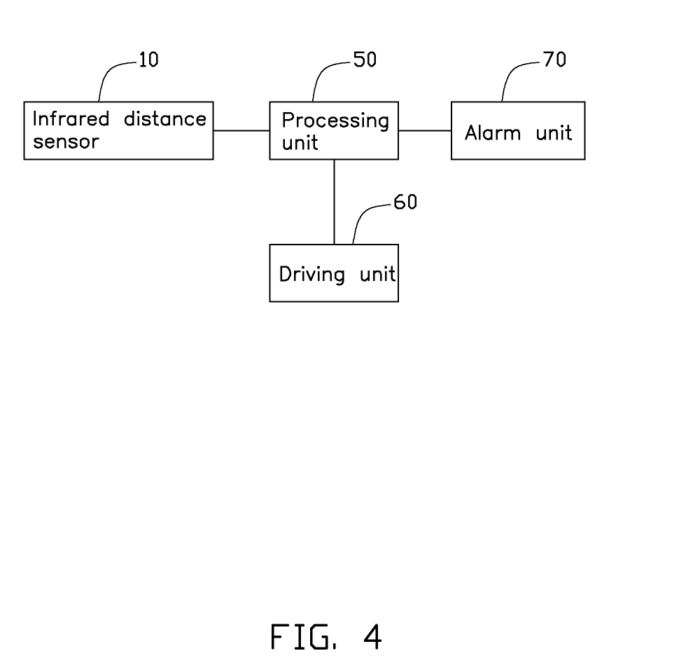

Referring to FIG. 4, in this embodiment, the mechanical hand 100 further includes a processing unit 50, a driving unit 60, and an alarm unit 70. The processing unit 50 is connected to the sensors 10. When the distance sensed by any of the sensors 10 is less than or equal to the preset value, the processing unit 50 activates the alarm unit 70 to raise an alarm for a preset time period, and controls the driving unit 60 to stop moving the main body 11. After the preset time period has elapsed, the processing unit 50 automatically controls the driving unit 60 to resume the motion of the main body 11. In an alternative embodiment, after the preset time period has elapsed, the processing unit 50 continues the state of non-motion by the main body 11. Upon receiving a command input by an operator, the processing unit 50 controls the driving unit 60 to resume the motion of the main body 11. The alarm unit 70 may be a sound output unit, or may be a number of light emitting diodes arranged on the outer surface of the mechanical hand 100.

In this embodiment, when there are people or foreign bodies near the mechanical hand 100, the mechanical hand 100 raises an alarm and stops moving. With such configuration, harm to people and harm to the mechanical hand 100 can be both avoided.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A mechanical hand comprising:
a main body;
a plurality of infrared distance sensors;
an alarm unit;
a driving unit configured to driving the main body to move; and
a processing unit configured to activate the alarm unit to operate for a preset time period and control the driving unit to stop moving the when a distance sensed by any of the sensors is less than or equal to a preset value.

2. The mechanical hand as described in claim 1, wherein the processing unit is further configured to automatically control the driving unit to resume the motion of the mechanical hand after the preset time period has elapsed.

3. The mechanical hand as described in claim 1, wherein the processing unit is to further configured to control the driving unit to resume the motion of the mechanical hand upon receiving a command input by an operator.

4. The mechanical hand as described in claim 1, further comprising a rotary arm, a first rotary shaft rotatably connected to the rotary arm, a second rotary shaft rotatably connected to the first rotary shaft, wherein the infrared distance sensors are arranged on the outer surfaces of the rotary arm, the first rotary shaft, and the second rotary shaft.

5. The mechanical hand as described in claim 1, wherein the rotary arm comprises an upper surface, a lower surface opposite to the upper surface, a left sidewall, and a right sidewall opposite to the left sidewall, the infrared distance sensors comprise a first, second, third, and fourth sensor arrays, the first sensor array is arranged on the upper surface, the second sensor array is arranged on the lower surface, the third sensor array is arranged on the left sidewall, and the fourth sensor array is arranged on the right sidewall.

6. The mechanical hand as described in claim 1, wherein the alarm unit is an audio output unit.

7. The mechanical hand as described in claim 1, wherein the alarm unit comprises a plurality of light emitting diodes.

8. The mechanical hand as described in claim 1, wherein the preset value is 50 mm.
